(19) United States
(12) Patent Application Publication
(10) Pub. No.: US 2011/0129310 A1
(43) Pub. Date: Jun. 2, 2011

(54) ANGLE-ROUNDING METHOD AND TOOL

(75) Inventors: Vincent Dessoly, Juvisy Sur Orge (FR); Marcel Claude Mons, Savigny Le Temple (FR); Ana Carmen Viguera Sancho, Alfortville (FR)

(73) Assignee: SNECMA, Paris (FR)

(21) Appl. No.: 13/057,916

(22) PCT Filed: Jun. 25, 2009
(86) PCT No.: PCT/FR09/00789

§ 371 Date: Feb. 7, 2011

(30) Foreign Application Priority Data
Aug. 8, 2008 (FR) 08/04535

(51) Int. Cl. B23C 5/12; B23C 3/12; B23B 27/00

(52) U.S. Cl. 407/56; 409/131; 407/65

(57) ABSTRACT

A method of angle rounding at an intersection between two surfaces of a workpiece, the method including machining away a minimum volume of material from the intersection of the two surfaces, thereby giving a convex rounded shape to the intersection of the two surfaces, the curved shape being located relative to the workpiece on the outside of a circular arc tangential to the two surfaces at the point where the curved shape connects with the two surfaces.

The present invention relates to an angle-rounding method and also to a tool for implementing such a method.

Numerous industrial workpieces have edges, e.g. a turbomachine compressor or turbine disk that has a plurality of slots (cells) distributed around its outside circumference for receiving the roots of blades. The bottom of each slot thus forms a plurality of edges in association with the upstream and downstream faces of the disk. Edges are also to be found on the flanges used for assembling disks together at the edges of fastener holes and at the edges of festoons. This situation may also be observed at the edges of metal sheets, e.g. for stiffening certain portions of a turbomachine, or indeed at the openings of an orifice formed through a wall of a workpiece.

These edges generally have burrs that are the result of making particular shapes (slots, orifices, cutouts, . . . ) in the workpiece. These burrs may be eliminated, for example, by mechanical angle-rounding or by tribo-finishing.

For this purpose, it is known to make a chamfer on the angle connecting the two surfaces together. It is also known to make a connection zone of circular section between the two surfaces, which zone has ends that are tangential to the two surfaces of the workpiece. That operation avoids any risk of injury while the workpiece is being handled and serves to eliminate burrs.

The portions of workpieces that correspond to those situations are zones in which there is a concentration of stresses that are subjected to cyclical variations of mechanical loading; those zones are thus subjected to fatigue and might suffer premature breakage.

A conventional angle-rounding or tribo-finishing operation leads to a geometrical configuration that is more or less well-controlled, and that influences the level of stress concentration in the connection zone, which level is very high with tribo-finishing or when providing a conventional chamfer (angle-rounding over 0.1 millimeters (mm) to 0.4 mm). Under the effect of force cycles, this increase in stress can lead to the formation of cracks that propagate in the two surfaces of the workpiece away from the connection zone. Such cracks may also propagate in the volume of the workpiece.

Crack formation shortens the lifetime of workpieces and increases maintenance costs, which may be high when that type of angle rounding is performed on parts that are critical, such as the rotor disks of a turbomachine.

In order to limit the risk of cracking, it is therefore desirable to limit the extent to which angle-rounding raises the level of stresses in the connection zone, and thus to machine a particular projecting shape that takes account of the local three-dimensional geometry. Nevertheless, for such angle-rounding to be performed correctly, it is not possible to reduce the radius of curvature of the connection zone below a certain limit.

The invention proposes a solution to the above problems of the prior art, which solution is simple, effective, and inexpensive.

The invention provides a method of angle rounding at the intersection between two surfaces of a workpiece, the method being characterized in that it consists in machining away a minimum volume of material from the intersection of the two surfaces, thereby giving a convex rounded shape to the intersection of the two surfaces, said curved shape being located relative to the workpiece on the outside of a circular arc tangential to the two surfaces at the point where the curved shape connects with the two surfaces.

For a given radius, the method of the invention makes it possible to reduce the volume of material that is removed by machining, since the connection zone of curved shape made by the method is located, relative to the workpiece, on the outside of a circularly arcuate connection zone as made in the prior art. Thus, when the minimum acceptable radius for rounding the angle is reached for a workpiece, it is possible with the method of the invention to make an angle-rounding curved shape that minimizes the volume of material that is removed. In this way, the level of stresses in the connection zone is reduced and the risk of cracks forming in the part is limited.

The ends of the curved shape of the invention are connected substantially tangentially to the two surfaces of the workpiece, thereby enabling a smooth junction to be made between the ends of the connection surface and the two surfaces of the workpiece, and enabling the rise of the stress level in the workpiece to be limited.

Advantageously, the curved shape is elliptical or parabolic in section.

According to another characteristic of the invention, the circular arc tangential to the two connection points has a radius lying in the range 0.4 mm to 3 mm, thus making it possible to optimize the zones of the most common three-dimensional workpieces by using approaches built up from finite elements and/or photoelasticimetry.

The intersection of the two surfaces may be machined by milling or trimming.

According to another characteristic of the invention, the method consists in using a single tool to act simultaneously to round the angle between the two surfaces and to perform finishing machining on one of the surfaces.

The angle rounding and the finishing machining operations are then performed during a single machining stage, thus avoiding the formation of discontinuities as can occur when those operations are performed one after the other as in the prior art.

The invention also provides a milling, or trimming tool for angle rounding at the intersection of two surfaces of a workpiece, the tool comprising a body extending along an axis of rotation of the tool and having teeth regularly distributed about said axis and spaced apart from one another by flutes for receiving swarf, the tool being characterized in that each tooth comprises at least one concave curved wall that is situated on the outside of a circular arc having its concave side facing towards the outside of the tool, and that is connected at its ends to the ends of the concave curved wall.

The invention also provides a turning tool for angle rounding at the intersection of two surfaces of a workpiece, the tool comprising a cutter plate having a concave curved cutting edge, the tool being characterized in that the concave curved cutting edge is situated relative to the workpiece for machining on the outside of a circular arc having its concave side facing towards the outside of the tool, and is connected at its ends to the ends of the cutting edge.

Advantageously, one end of the concave wall or of the cutting edge is extended by a finishing machining wall that extends axially. Adding a finishing machining wall to the tool makes it possible to perform both the angle rounding and the finishing operations in a single machining step.

Each finishing machining wall may be extended by a second concave curved wall or edge at its end opposite from the first concave curved wall or edge, said second concave curved wall or edge being situated on the outside of a circular arc with its concave side facing towards the outside of the tool and connected at its ends to the ends of the second concave curved wall or edge.

Such a tool makes it possible in a single machining operation simultaneously to round two angles situated at the ends of a single surface, and to perform finishing machining on the surface situated between the two angles. This type of tool serves to avoid any machining discontinuity being formed in the surface between the two angles.

According to another characteristic of the invention, the concave curved walls or edges are elliptical or parabolic in section.

The invention can be better understood and other details, advantages, and characteristics of the invention appear on reading the following description made by way of non-limiting example and with reference to the accompanying drawings, in which:

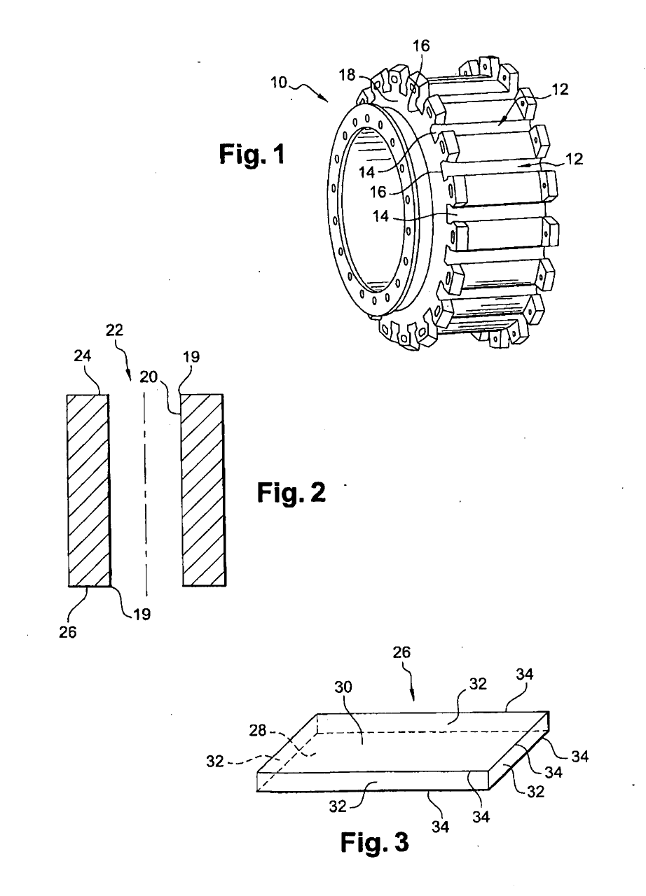

FIG. 1 is a diagrammatic perspective view of a rotor disk in a turbomachine;

FIGS. 2 and 3 are diagrammatic views respectively in section and in perspective and respectively showing an orifice formed in a wall and a metal sheet;

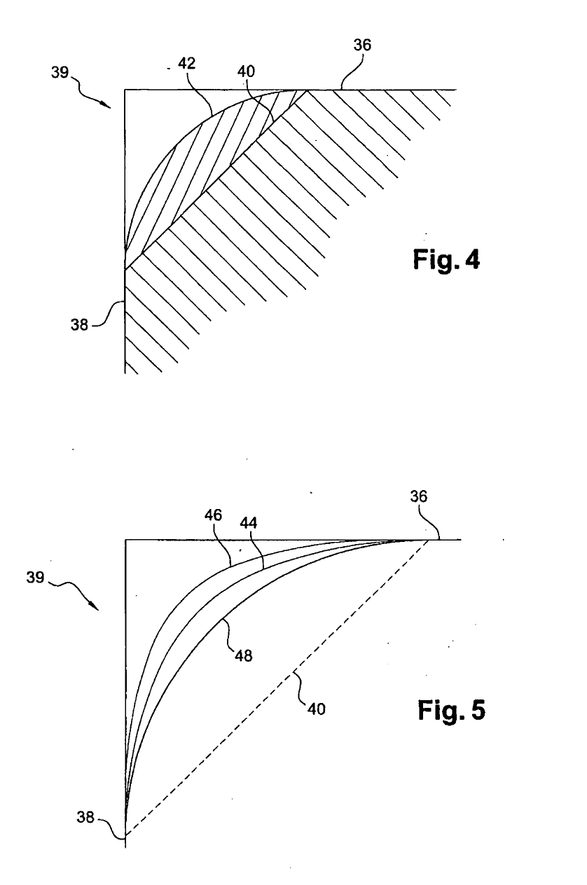

FIG. 4 is a diagrammatic section view of angle rounding in the prior art;

FIG. 5 is a diagrammatic section view of angle rounding as obtained by the method of the invention;

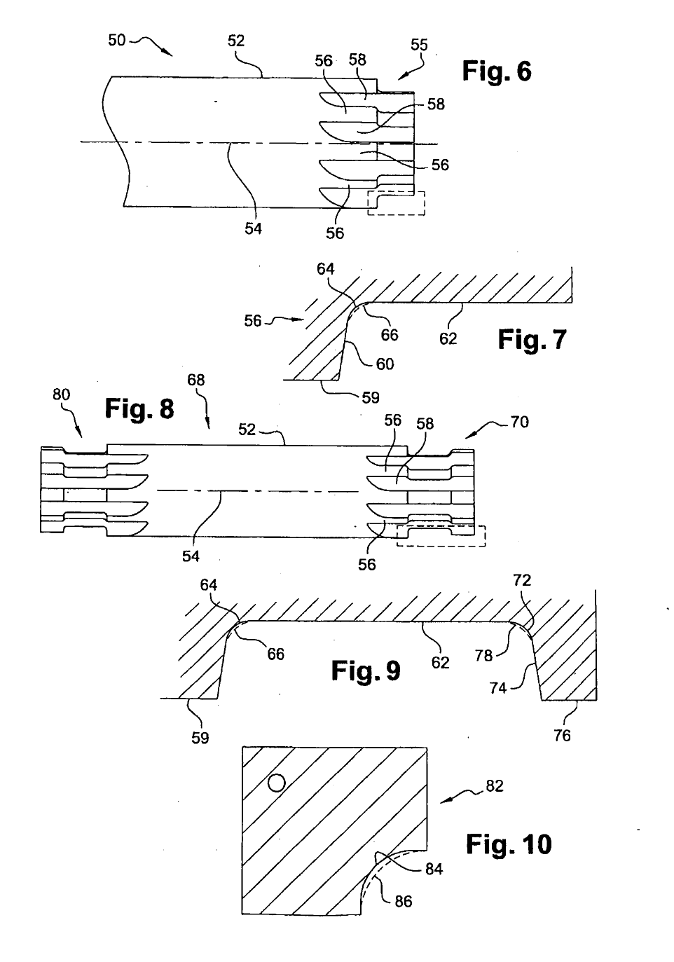

FIG. 6 is a diagrammatic side view of a milling or trimming tool for implementing the method of the invention;

FIG. 7 is a view on a larger scale of the region outlined in dashed lines in FIG. 6;

FIG. 8 is a diagrammatic side view of a variant of a milling or trimming tool for implementing the method of the invention;

FIG. 9 is a view on a larger scale of the region outlined in dashed lines in FIG. 8; and

FIG. 10 is a diagrammatic section view of a trimming plate for implementing the method of the invention.

Reference is made initially to FIG. 1, which shows a rotor disk 10 in a turbomachine that has axial slots 12 regularly distributed in its outer periphery. These slots 12 are for receiving respective blade roots that are engaged axially and held radially in the slots 12.

The bottom surface 14 of each slot 12 thus forms right-angled edges 16 with the upstream face 18 and the downstream face of the disk 10. While the slots 12 are being formed in the disk 10, burrs form at the above-mentioned edges. These edges 16 need to be machined in order to eliminate the burrs and avoid any risk of injury to an operator handling the disk 10.

Other edges also need to be machined, such as the edges 19 formed at the intersection between the inside surface 20 of an orifice 22 and the surfaces 24 into which the orifice opens out (FIG. 2). FIG. 3 shows a metal sheet 26 having bottom and top faces 28 and 30 connected together by side walls 32. The intersections of the bottom and top walls with the side walls thus form a plurality of edges 34 that need to be machined.

This machining operation consists in rounding the angle situated at the intersection between two surfaces 36, 38. For this purpose, and as shown in FIG. 4, a chamfer 40 or a convex connection zone 42 of circular section is formed at the intersection.

Nevertheless, that type of angle rounding gives rise to an increase in the level of stresses in the connection zone formed in that way, which can lead to cracks forming that, on propagating, might lead to the workpiece bursting, which it is essential to avoid in critical parts such as rotor disks.

Compared with making a chamfer, angle-rounding by forming a circular section connection zone 42 limits the extent to which stresses are raised in the connection zone because its ends are tangential to the surfaces 36 and 38 of the workpiece and because the volume of material that is removed is smaller. Nevertheless, such angle-rounding is not satisfactory since the connection radius formed in this way must not be less than a certain limit in order to ensure that the angle is well rounded.

The invention provides a solution to these problems of the prior art by means of an angle-rounding method that enables a minimum volume of material to be removed from the intersection of two surfaces 36 and 38 of a workpiece 39, thereby limiting the increase in the stress level due to the angle-rounding operation (FIG. 5).

For this purpose, the method consists in giving a convex curved shape 44, 46 to the intersection of two surfaces 36, 38 in such a manner that the curved shape 44, 46 is situated, relative to the workpiece, on the outside of a circular arc 48 that is tangential to the two surfaces 36 and 38 at the points where the curved shape 44, 46 connects with the two surfaces 36, 38.

Thus, for a circular arc of given radius 48, the outside surface 44, 46 of curved shape is situated outside said circular arc, thereby enabling less material to be removed during the machining operation than would be removed if a chamfer 40 or a connection zone 48 of circular shape were to be made.

The ends of the curved shape 44, 46 are connected to the surfaces 36, 38 of the workpiece at the points where the circular arc 48 of given radius is tangential to the surfaces of the workpiece 36, 38, thus making it possible to have a smooth connection for the curved shape 44, 46 with the surfaces 36, 38 of the workpiece 39. This limits the increase in stresses in the connection zone 44, 46 and avoids cracks forming therein.

This curved shape 44, 46 may be of elliptical section 44 or of parabolic section 46, for example.

The circular arc 48 of given radius may have a radius lying in the range 0.4 mm to 3 mm, and preferably in the range 0.4 mm to 1.6 mm.

In order to implement the method of the invention, milling, trimming, or turning tools may be used, and they are shown in FIGS. 6 to 10.

The tool 50 shown in FIG. 6 comprises a body 52 of elongate shape extending along an axis 54 of rotation. One end of the body 52 of the tool 50 is for fastening by appropriate means to the chuck of a machine tool, the other end comprising an active or working portion 55 that serves to round the angle. The active portion 55 comprises teeth 56 that are regularly distributed around the axis 54 of the tool and that are separated from one another by flutes 58 for receiving swarf.

Each tooth 56 extends substantially axially and has a cylindrical outer wall 59 connected to the outside end of a substantially radial wall 60. The radially inner end of the radial wall 60 is connected to a substantially cylindrical inner wall 62 via a concave curved wall 64.

The concave curved wall 64 is situated on the outside of a circular arc 66 with its concave side directed towards the outside of the tool 50 and with its ends connected to the ends of the concave curved wall 66 as shown in FIG. 7.

In this way, when the concave curved wall 64 of the tool is applied to an edge, the machining operation serves, for given radius 66, to remove less material from the edge of the workpiece.

The cylindrical inner wall 62 of each tooth forms a machining wall for finishing that serves to avoid forming a discontinuity at the junction between the convex connection zone 44, 46 formed on the workpiece and the surface of the workpiece against which the finishing machining wall is applied.

In another variant embodiment of a milling or drilling tool 68, the working portion 70 comprises a second concave curved wall 72 having one end connected to the end of the finishing machining wall 62 that is opposite from the first concave curved wall 64 (FIG. 9). The other end of the second concave curved wall 72 is connected to the inside end of a substantially radial wall 74 having its outside end connected to a second outer cylindrical wall 76.

This second concave curved wall 72 is likewise situated on the outside of a circular arc 78 of the tool with its concave side facing outwards. The ends of the circular arc 78 are connected to the ends of the second concave curved wall 72 (FIG. 7).

This tool 60 has a second working portion 80 situated on the body 52 at its end opposite from the first working portion 70. This second working portion 80 is for use once the first working portion 70 is worn.

Incorporating a second concave curved wall 72 for angle rounding enables two edges to be machined simultaneously with finishing machining being applied to the surface between the two edges. Unlike the above-described technique, in which it is necessary to round the angle of each edge and then to perform finishing machining on the surface between them, this tool enables a single machining and finishing operation to be performed on a single pass of the tool on the workpiece.

This tool is thus particularly adapted to simultaneous machining of the edges at the intersections between the side walls 32 and the bottom and top walls 28 and 30 of a metal sheet 26 (FIG. 3). The inner cylindrical wall 62 of the tool 68 serves to perform finishing machining on the side walls 32 and avoids any discontinuity on the side walls 32 as a result of angle rounding and finishing machining being performed simultaneously.

Such a tool 68 may also be used for simultaneously machining both end edges 19 of an orifice 22 (FIG. 2). To do this, it is necessary for the diameter of the end of the working portion 70, 80 at the second outer cylindrical wall 76 to be less than the diameter of the orifice 22, so that the tool 70, 80 can be inserted through the orifice 22.

FIG. 10 shows a cutter plate 82 of a turning tool having a concave curved cutting edge 84 with its ends connected to the edges of the plate. Relative to the workpiece for machining, the cutting edge 84 is situated on the outside of a circular arc 86 having its concave side facing outwards from the tool 82 and having its ends connected to the ends of the cutting edge 84. In a variant, the cutter plate 82 may include two opposite cutting edges connected together via a finishing edge, like the tool of FIGS. 8 and 9.

The concave curved walls or edges 66, 68, 86 of the tools may be elliptical or parabolic section.

The invention is not limited to the particular embodiments of tools shown in the drawings, and it is possible to modify the characteristics of those tools. For example, the teeth may extend helically around the axis of the tool.

In the description, angle-rounding is performed on an edge formed by the intersection between two perpendicular surfaces of a workpiece. Nevertheless, it can be understood that the method is not limited to rounding a right-angled edge and may be used for rounding edges formed at the intersection between two surfaces that are not perpendicular.

The invention is not limited solely to the field of mechanical workpieces used in aviation, and it may be used in other fields such as the automotive field, where the same problems arise.

1-10. (canceled)

11. A method of angle rounding at an intersection between two surfaces of a workpiece, the method comprising:
machining away a minimum volume of material from an intersection of the two surfaces, thereby giving a convex rounded shape to the intersection of the two surfaces, the curved shape being located relative to the workpiece on an outside of a circular arc tangential to the two surfaces at a point where the curved shape connects with the two surfaces.

12. A method according to claim 11, wherein the curved shape is elliptical or parabolic in section.

13. A method according to claim 11, wherein the circular arc tangential to the two connection points has a radius lying in a range 0.4 mm to 3 mm.

14. A method according to claim 11, wherein the intersection of the two surfaces is machined by milling or trimming.

15. A method according to claim 11, further comprising using a single tool to act simultaneously to round an angle between the two surfaces and to perform finishing machining on one of the surfaces.

16. A milling, trimming tool for angle rounding at an intersection of two surfaces of a workpiece, the tool comprising:
a body extending along an axis of rotation of the tool and including teeth regularly distributed about the axis and spaced apart from one another by flutes for receiving swarf,
wherein each tooth includes at least one concave curved wall situated on an outside of a circular arc having its concave side facing towards the outside of the tool, and that is connected at its ends to ends of the concave curved wall.

17. A tool according to claim 16, wherein one end of the concave wall or of the cutting edge is extended by a finishing machining wall that extends axially.

18. A tool according to claim 17, wherein each finishing machining wall is extended by a second concave curved wall or edge at its end opposite from the first concave curved wall or edge, the second concave curved wall or edge also being situated on the outside of a circular arc with its concave side facing towards the outside of the tool and connected at its ends to the ends of the second concave curved wall or edge.

19. A tool according to claim 18, wherein the concave curved walls or edges are elliptical or parabolic in section.

20. A turning tool for angle rounding at the intersection of two surfaces of a workpiece, the tool comprising:
a cutter plate including a concave curved cutting edge, wherein the concave curved cutting edge is situated relative to the workpiece for machining on an outside of a circular arc having its concave side facing towards the outside of the tool, and is connected at its ends to ends of the cutting edge.

21. A tool according to claim 20, wherein one end of the concave wall or of the cutting edge is extended by a finishing machining wall that extends axially.

22. A tool according to claim 21, wherein each finishing machining wall is extended by a second concave curved wall or edge at its end opposite from the first concave curved wall or edge, the second concave curved wall or edge also being situated on the outside of a circular arc with its concave side facing towards the outside of the tool and connected at its ends to the ends of the second concave curved wall or edge.

23. A tool according to claim 22, wherein the concave curved walls or edges are elliptical or parabolic in section.
